(19) United States
(12) Patent Application Publication
(10) Pub. No.: US 2009/0023500 A1
(43) Pub. Date: Jan. 22, 2009

(54) Portable multi-user video game and display system and a portable apparatus for use therein

(76) Inventor: Paul Pflum, Winfield, WV (US)

Correspondence Address: Paul Pflum, 108 Rolling Acres, Winfield, WV, 25213, US

(21) Appl. No.: 11/880,077

(22) Filed: Jul. 20, 2007

(51) Int. Cl. A63F 13/08

(52) U.S. Cl. 463/46

(57) ABSTRACT

An easily transportable apparatus that contains one or more video game systems displayed on one or more video monitors within a sturdy, lightweight enclosure. The video game systems, such as, but not limited to, Xbox® or Playstation®, are networked together within the enclosure to allow the users to play separate games individually, or the same game simultaneously, with each game being displayed on a separate video monitor, such as an LCD or flat screen monitor. The apparatus can easily be connected to one or more identical apparatus allowing additional users to participate in the same game. All connections are maintained within the enclosure, with the exception of a power cord and, if desired, a network cable to attach other apparatus.

### CROSS-REFERENCE TO RELATED APPLICATIONS

Not Applicable

### STATEMENT REGARDING FEDERALLY SPONSORED RESEARCH

Not Applicable

### REFERENCE TO SEQUENCE LISTING

Not Applicable

### BACKGROUND OF THE INVENTION

The present invention relates to a portable apparatus that allows multiple users to play separately or against each other on one or more video game systems at a single location. Currently, if users wish to play against each other it involves the use of multiple and separate pieces of equipment that are cumbersome to carry and configure, or, at the very least, to share a single video monitor, thus reducing the viewing size for each player.

### BRIEF SUMMARY OF THE INVENTION

The present invention represents and attempt to simplify the above-mentioned process by combining all necessary components into a single, portable box, that allows each user the use of a separate video screen and game console. There is an added feature of being able to easily connect multiple portable devices allowing even more users the same advantages and convenience.

### BRIEF DESCRIPTION OF THE DRAWINGS

FIG. 1 is a diagram of the apparatus as seen from the front, showing the location of the two gaming consoles, storage space, and general construction.

FIG. 2 is a diagram of the apparatus showing the top, front, and right-side views. Included with the items from FIG. 1 is one of the two video monitors shown on the right with corresponding clear cover, as well as the handle and hinges for the storage space cover (top of apparatus).

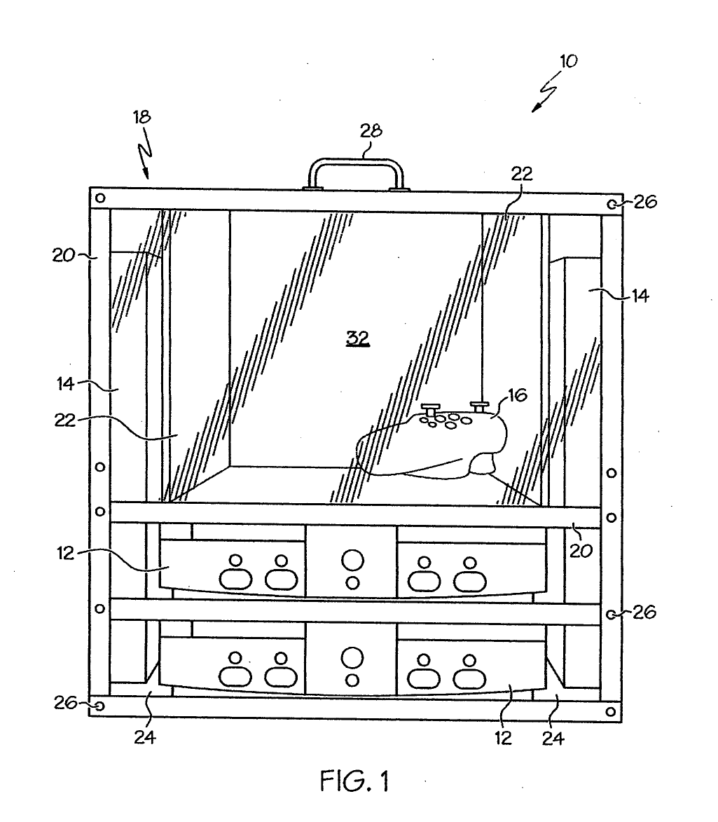

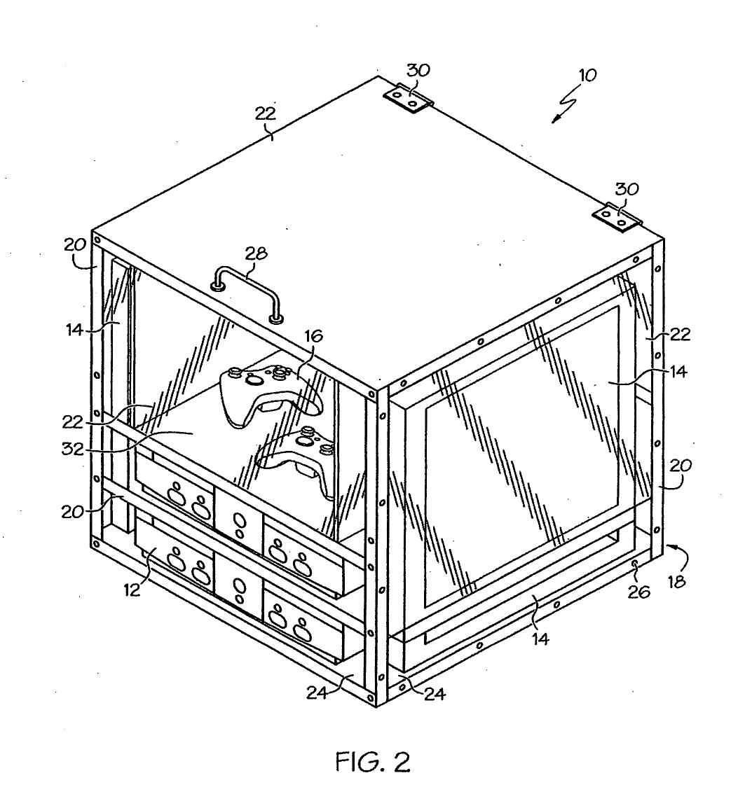

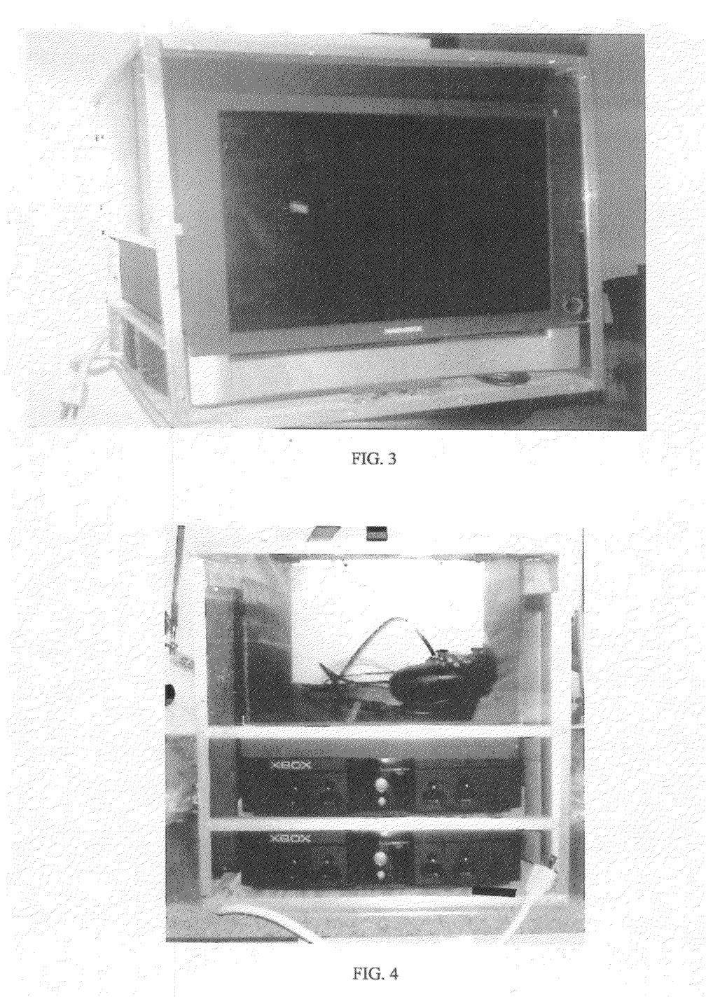

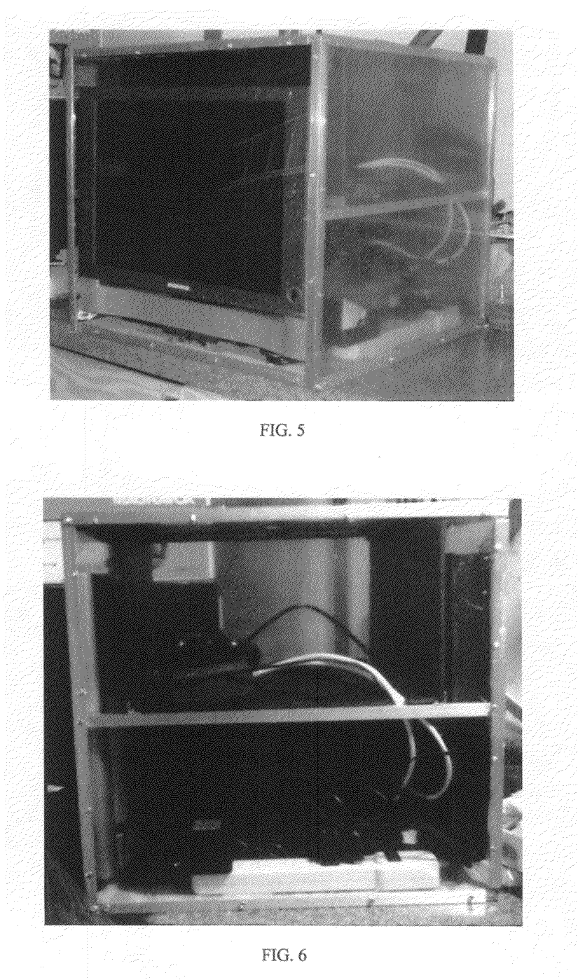

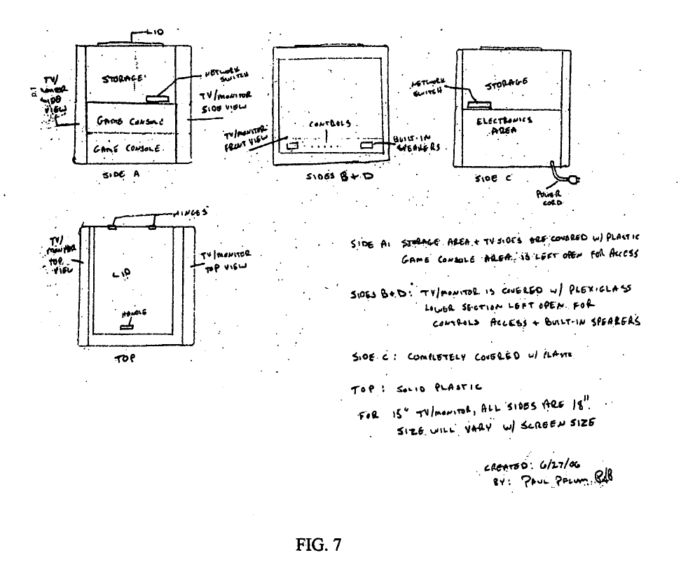

### PORTABLE MULTI-USER VIDEO GAME AND DISPLAY SYSTEM AND A PORTABLE APPARATUS FOR USE THEREIN

Embodiments of the present invention relates to a portable multi-user video game and display system 10 configured to allow more than one user to play more than one video game system 12 displayed on more than one monitor 14 all at the same time while at a single location. Other embodiments of the present invention further relates to a portable apparatus 18 configured to store more than one video game system 12 and more than one monitor 14 in a viewable, accessible, and usable manner to more than one user. Another embodiment of the present invention further relates to a method of providing more than one video game system 12 and more than one monitor 14 to a portable apparatus 18 such that the video game systems 12 and the monitors 14 are confined within said apparatus 18 while remaining viewable and accessible to more than one user. Lastly, another embodiment of the present invention relates to a method of enabling more than one user to play more than one video game system 12 at the same time while at a single location by providing said video game systems 12 and more than one monitor 14 to at least one portable storage apparatus 14.

The portable multi-user video game and display system 10 generally comprises more than one video game system 12, more than one monitor 14, a network connection, and a portable apparatus 18. The portable system 10 generally is configured such that the video game systems 12, the monitors 14, and the network cable are stored inside of the portable apparatus 18 in a viewable, accessible, and usable manner to the users of the multi-user system 10. The video game systems 12 utilized with this multi-user system 10 may be any of those commonly available, such as, but not limited to, Xbox® and PlayStation®. The monitors 14, meanwhile, generally may be configured as LCD or flat panel monitors so as to restrict their size and weight. The exact dimensions of the monitors 14 utilized with the multi-user system 10 depend on the size and dimensions of the portable apparatus 18 to which the monitors are provided. The network connection of the portable system 10 generally comprises a network switch and cables that may be used to link the video game systems 12. In addition, the video game systems 12 may be connected to other video game systems stored in another portable apparatus 18, such that more than one apparatus each storing multiple video game systems 12 and monitors 14 may be interconnected and located in the same location. The network switch and cables further allow users to engage in internet gaming. The portable apparatus 18 may be any moveable device that is configured to store the video game systems 12 and monitors 14 in a viewable, accessible, and usable manner.

The portable apparatus 18 of the present invention generally may be configured to store more than one video game system 12 and more than one monitor 14 so that separate games can be played on separate systems and displayed on separate monitors by multiple users. Alternatively, the apparatus 18 may be configured to allow multiple users to play the same game on separate systems 12 and displayed on separate monitors 14 at the same time through a network connection and/or internet-based gaming. This portable apparatus 18, storing multiple video game systems 12 and monitors 14, enables both of these scenarios, or any combination thereof, to take place all at the same time while at a single location. In addition, the portability of the apparatus 18 of the present invention enables a user to easily transport the apparatus, and the video game systems 12 and monitors 14 stored therein, to another location, whether to a room next door or into a car to be taken elsewhere, or otherwise.

The apparatus 18 of the present invention generally comprises a frame 20 and walls 22 that enclose the flame 20. The flame 20 generally is comprised of a plurality of braces. It is contemplated that the frame 20 may be comprised of any narrow but strong and rigid material, such as, but not limited to, aluminum tubes. The braces of the frame 20 typically are configured as flat bars that extend along a longitudinal axis. Further, the braces generally are connected at terminal ends with common connecting means 26, such as, but not limited to, nuts, bolts, screws, and/or molded nylon components, so as to shape the flame 20 in a square or rectangular, or other, configuration.

The walls 22 of the apparatus generally are secured to at least three of the four lateral sides and the top and bottom sides of the shaped flame 20. The lateral and top walls 22 generally are configured as thin, yet strong sheets secured along their peripheral edges to the braces of the frame 20. At least two of the lateral walls 22, and potentially the top and/or bottom walls 22, are configured of a transparent material, such as, Plexiglas®. The top wall 22 may be connected to the frame 20 by one or more hinges 30 so that the top wall 22 may open or close access to the inside of the apparatus 18. A handle 28 may be secured to the exterior face of the top wall 22 to further ease the opening and closing of the top wall 22. Further, handle areas may be provided to two or more of the lateral walls 22 to more easily enable a user to transport the apparatus 18. The bottom wall 22 of the apparatus 18, meanwhile, generally is sealed with a rigid, supportive base 24. This base 24 may be configured with a strength sufficient to support the weight of the video game systems 12 and monitors 14 that are to be stored within of the frame 20 and walls 22 of the apparatus 18. In addition, a bottom side of the base 24 may be secured to a plurality of wheels to further enhance the portability of the apparatus 18 during transportation.

This apparatus 18 may be offered in a variety of sizes proportional to the various dimensions of available monitors 14 and video game systems 12. Each monitor 14 may be placed inside of the apparatus 18 through the opening of the top wall 22. Each monitor 14 may be positioned in the apparatus 18 so as to face out from behind a transparent wall 22 of the apparatus. Generally, the transparent walls 22 cover and protect the screens of the monitors 14, but provide space for a user to adjust the image or other functions of the monitors, as such adjustment options typically are provided under the monitor screen.

The video game systems 12 may then be placed inside of the apparatus 18 through the open top wall 22 and positioned behind the monitors 14 with the faces of the systems 12 facing out through an at least partially open lateral side of the apparatus 18. This partially open lateral side of the apparatus 18 generally has only a portion of a wall 22 that covers only the area of this lateral side that is not directly before the faces of the video game systems 12, depending on the number of systems 12 placed in the apparatus. It is contemplated by the present invention, however, that this partially open lateral side, or any side if so desired, may have a wall 22 hinged to the frame 20 so that this wall 22 may swing open to provide access to the faces of the video game systems 12. Access to the faces of the video game systems 12 generally is necessary to enable a user, or users, to change video games 12, controllers 16, and other video game system accessories. The apparatus 18, however, may be configured such that the video game systems 12 may not be removed from this partially open lateral side, or other sides of the apparatus. This may be achieved by portions of a wall 22 being secured to the frame 20 to obstruct at least a portion of the dimensions of the video game systems 12 such that they may not be removed from the inside of the apparatus 18 through this partially open lateral side. Alternatively, additional one or more metal braces, identical or similar to the braces of the flame 20, may be secured at their terminal ends to the frame 20 so as to horizontally cross the partially open lateral side. These additional braces may be secured to the frame 20 at positions appropriate to obstruct a portion of the dimensions of the video game systems 12 such that they may not be removed from the inside of the apparatus 18 through the partially open lateral side. It is contemplated by the present invention that additional and/or alternative measures may be taken to prevent the removal of the video game systems 12 from the apparatus 18.

The video game systems 12 placed inside of the apparatus 18 generally, but not necessarily, are stacked so as to minimize the space consumed within the apparatus. Depending on the size of the apparatus 18 and the number of video game systems 12 stored therein, there may be additional space available within the apparatus to serve as a storage area 32 for video games, controllers 16, a network switch, network cables, and/or other video game accessories. This storage area 32 generally exists between the top of the stacked video game systems 12 and the top wall 22 of the apparatus 18. As mentioned above, the top wall 22 may be hinged to the frame 20 to allow for easy access to the inside of the apparatus 18 and to the storage area 32. In addition, there generally is space within the apparatus 18 for all of the necessary power cords and video cords to be inter-connected where necessary and connected to a power strip surge protector. The cord and plug for this power strip may then pass through a small hole in a wall 22 of the apparatus 18 and plugged into an electrical outlet. Thereby, all of the other power cords and video cords may be stored out of the reach of the users.

It is noted that terms like “preferably,” “generally,” “commonly,” and “typically” are not utilized herein to limit the scope of the embodiments of the claimed invention or to imply that certain features are critical, essential, or even important to the structure or function of the claimed invention. Rather, these terms are merely intended to highlight alternative or additional features that may or may not be utilized in a particular embodiment of the present invention.

Having described embodiments of the invention in detail, it will be apparent that modifications and variations are possible without departing from the scope of the embodiments of the invention defined in the appended claims.

What is claimed is:

1. A portable multi-user video game and display system including one or more of the novel features described in the above specification and in the accompanying drawings.

2. A portable multi-user video game and display system substantially as described in the above specification and in the accompanying drawings.

3. A portable apparatus including one or more of the novel features described in the above specification and in the accompanying drawings.

4. A portable apparatus substantially as described in the above specification and in the accompanying drawings.

5. A method of providing more than one video game system and more than one monitor to a portable apparatus such that said video game systems and said monitors are confined within said apparatus while remaining viewable, accessible, and usable to more than one user.

6. A method of enabling more than one user to play more than one video game system at the same time while at a single location by providing said video game systems and more than one monitor to at least one portable storage apparatus.
